(19) United States
(12) Patent Application Publication
(10) Pub. No.: US 2016/0093886 A1
(43) Pub. Date: Mar. 31, 2016

(54) Lithium-sulfur cell and battery

(71) Applicant: Robert Bosch GmbH, Stuttgart (DE)

(72) Inventors: Stefan Doerne, Stuttgart (DE); Ulrich Hasenkox, Ditzingen (DE); Christoph Brehm, Hatvan (HU); Lutz Baumgaertner, Stuttgart (DE)

(21) Appl. No.: 14/867,799

(22) Filed: Sep. 28, 2015

(30) Foreign Application Priority Data
Sep. 30, 2014 (DE) 10 2014 219 839.9

(51) Int. Cl. H01M 4/587; H01M 2/14; H01M 10/052

(52) U.S. Cl. CPC H01M 4/587; H01M 10/052; H01M 2/14

(57) ABSTRACT

A lithium-sulfur cell for a battery includes: a negative electrode; a positive electrode; and at least one diffusion barrier situated between the negative electrode and the positive electrode. At least one of the negative and positive electrodes includes a porous graphite foil made of expanded graphite, and the at least one diffusion barrier is composed of a brittle material having a thickness of ≧10 μm. At least two lithium-sulfur cells are provided in an interconnected arrangement in a battery.

### BACKGROUND OF THE INVENTION

1. Field of the Invention

The present invention relates to a galvanic battery cell, in particular a rechargeable lithium-sulfur battery cell, including a negative and a positive electrode and a diffusion barrier. The present invention further relates to a rechargeable battery including at least two of the lithium-sulfur battery cells according to the present invention.

2. Description of the Related Art

The term battery here shall mean that at least two battery cells are interconnected. The terms battery cell and cell are used synonymously in the present document.

Batteries generally convert chemical reaction energy into electrical current, the reaction partners in a charged battery being present in separate physical locations, and the chemical reaction only being able to take place when one of the involved reaction partners is transported as an ion. Of late, highly developed rechargeable lithium-ion secondary batteries, that is, a parallel or serial connection of multiple individual electrically interconnected rechargeable battery cells to form a battery pack or a so-called battery module, are increasingly used in various fields of technology. The lithium ion transport is controlled by electrical current in the external circuit since lithium is neutral when present in its original state. The energy released at the cathode during the highly exothermic reaction is subsequently converted into electrical power in the external circuit. Known application options for such batteries include electronic consumer goods, among other things, such as mobile telephones, smart phones, portable computers, video cameras or MP3 players.

Of late, intercalation materials are increasingly used for the active materials used in the known application options on the anode and cathode sides. Compared to conventional anode and cathode materials, they have the advantages of lower volume changes during charging and discharging processes and high reversibility of the extraction and insertion processes, whereby they are able to provide a very high cycle stability. The active material in such electrodes is generally fixed on a metallic current collector foil having layer thicknesses of 50 μm to 150 μm using a polymer binder, such as polyvinylidene fluoride (PVDF). In addition, conductive carbon black and graphite are integrated into the coating on the cathode to ensure sufficient conductivity for electrons from the active material to the current collector foil. The active material is typically applied onto a copper foil as the current collector foil on the anode and onto an aluminum foil as the current collector foil on the cathode. Present lithium-ion batteries thus make sufficient to very good energy densities, discharge rates and cycle strengths possible, the weight and the battery price for the above-described products being acceptable.

However, lithium-ion battery cells have the disadvantage that their energy density is not high enough to sufficiently supply electric vehicles or electric hybrid vehicles, for example, in particular in order to achieve a satisfactory range of the vehicle, for example. Research in this technical field consequently strives to develop new concepts for secondary battery cells, the manufacturing costs of which remain within a manageable range.

The most promising future concept for secondary batteries at present is lithium-sulfur-based, which are to overcome the known limitations with respect to the unsatisfactory energy density and the manufacturing costs which are to be kept low. Compared to lithium metal compound oxides, such as nickel-cobalt-manganese (NCM), sulfur represents a more promising active material with regard to the energy density and the costs. The reaction of sulfur (S) with lithium (Li) takes place in multiple steps from S via Li₂Sₙ (2>n>8) to Li₂S and according to more recent studies has a high theoretical energy density of 500 Wh kg⁻¹. As with the known NCM materials, sulfur also has to be fixed to the current collector foil using a polymer binder and provided with a conductive carbon black or graphite content for better electron conduction.

Present lithium-sulfur batteries do not yet have sufficient cycle strength since, on the one hand, a transition between sulfur and lithium sulfur entails significant volume changes and, on the other hand, several of the resulting lithium sulfur compounds are dissolved in the electrolyte and may deposit on the anode, and thus result in an undesirable degradation of the active material. One approach for reducing the problems which the volume change entails is, for example, the use of very porous graphite having a high binder content. Such a use of porous graphite is known from published German patent application document DE 10 2011 077 932 A1, for example, in which the same is used as a cathode current collector material of a lithium-sulfur battery. The use of highly porous graphite as the current collector material, however, makes a wet-chemical coating with active material difficult and uneconomical since liquid fractions remain in the graphite material due to the porosity and capillary effects, or must be driven out using complex drying processes.

One approach for reducing the problems that the solubility of the lithium-sulfur compounds in the electrolyte entails may be solved by diffusion barriers for sulfur or lithium sulfur compounds, for example. However, such a diffusion barrier must be conductive for lithium ions. However, known diffusion barriers, such as from the class of the oxides of garnets of the general formula Li₇₋ₓLa₃Zr₂O_{12-y}, it also being possible for these to be doped with small amounts of other elements, or of the lithium phosphates of the general formula Li₁₊ₓM¹₂₋ₓ(PO₄)₃, are usually very thin and brittle in their application form, so that their handling during use, among other things in winding cells, presents itself to be more than problematic.

### BRIEF SUMMARY OF THE INVENTION

In order to face the above-mentioned problems of the related art, the present invention provides a lithium-sulfur cell for a battery which includes a negative electrode, a positive electrode, and at least one diffusion barrier situated between these. At least one of the electrodes includes a porous graphite foil made of compressed graphite, it being possible for the electrode to preferably be composed entirely of the porous graphite film made of compressed graphite. Furthermore the at least one diffusion barrier is made of a brittle material having a thickness of ≧10 μm, preferably having a thickness between 10 μm and 2 mm, further preferably having a thickness of approximately 50 μm. A brittle material is to be understood to mean a substance which initially becomes elastically deformed only very little under the action of a force and irreversibly fails when a critical force load is exceeded. This force load may act as a stretch, compression or bending load. Brittle materials are characterized by a low breaking elongation of <0.2% at room temperature, so that forces which result in a minor deformation of the material cause sudden failure. Brittle materials generally have a modulus of elasticity of >50 GPa and a Vickers hardness HV10>5 GPa. Compressed graphite may refer in particular to a graphite material made up of loose graphite pieces, which is compressed with the aid of a roller compression process, also referred to as calendering, or the like, or compacted by pressing. Compared to known electrodes, which are used in winding cells, for example, it is thus possible to create thick electrodes, without having to tolerate the disadvantages of the production of known electrodes, such as the use of slurries and the associated drying processes. More precisely, for example, organic solvents are used to suspend the active mass in a slurry with conductive material, such as a conductive carbon black/graphite mixture, and binder, such as PVDF, in order to manufacture present lithium-ion cathodes using lithium metal compound oxides. These so-called slurries are subsequently applied onto the aluminum foil acting as the current collector foil on the cathode and must thereafter be dried in furnace processes. This complex and cumbersome manner of manufacturing may be avoided with the novel lithium-sulfur cell according to the present invention. Moreover, the novel lithium-sulfur cell according to the present invention allows absolutely tight sealing to be achieved between the anode and the cathode, which is not achieved in today's battery cells, and which makes it possible to suppress the polysulfide diffusion to the anode side, in particular in lithium-sulfur cells.

Preferably at least one of the electrodes may be composed entirely of the compressed graphite. Further preferably, it is also possible for each of the two electrodes to include a porous graphite foil made of compressed graphite, or else to be composed entirely of the same. Correspondingly, the present invention also provides a method for manufacturing an electrode for such a lithium-sulfur cell, the porous graphite foil being manufactured in a calender gap using a compression process. In the process, expanded graphite is preferably compressed in the calender gap, further preferably a line load in the calender gap being 6000 N/mm. The functional principle during the manufacture of electrodes by compression thus includes a mechanical interlocking of the graphite, preferably of expanded graphite, to form foils under high pressure in calenders, i.e., based on at least one calender roll gap, for example having a line load of the gap of 6000 N/mm. In this way a porous graphite foil is achievable, which may be used directly as a basis for an anode, for example, furthermore uncompressed graphite having to be intercalated as anode active material. However, it is also possible to insert or intercalate cathode active materials into such a porous graphite foil. For this purpose, active material from the class of the lithium metal compound oxides, such as NCM, or else sulfur, sheathed with PVDF and conductive carbon black, for example, in an intercalation process is added to the expanded graphite. One of the advantages of the graphite foil is that it is electrically conductive itself and thus supports the electrical contact by multiple conductive percolation paths between the current collector foil and the active material.

In the lithium-sulfur cell of the present invention, active material sheathed with binder and conductive carbon black is preferably compressed with the positive electrode, sulfur being intercalatable into this electrode, and lithium being intercalatable into the negative electrode. A known diffusion barrier in such a lithium-sulfur battery cell is usually composed of a brittle ceramic, which due to its brittleness may not be used in a winding cell. A brittle ceramic is to be understood to mean a ceramic material which initially becomes elastically deformed only very little under the action of a force and irreversibly fails when a critical force load is exceeded. This force load may act as a stretch, compression or bending load. Brittle materials are characterized by a low breaking elongation of <0.2% at room temperature and generally have a modulus of elasticity of >50 GPa and a Vickers hardness HV10>5 GPA, so that forces which result in a minor deformation of the material cause sudden failure. Such diffusion barrier plates are unstable, i.e., extremely fragile, in thin layer thicknesses having a low weight, so that they may not be used in a controlled manner in the production of stacked cells. Moreover, such a diffusion barrier within the battery cell requires a seal toward the edge of the diffusion barrier, the use of which is very difficult and complex to implement in thin diffusion barrier plates.

With a lithium-sulfur cell of the present invention, it is now possible to use a stable diffusion barrier, preferably in the form of a ceramic foil or a ceramic plate, i.e., a more rigid diffusion barrier having a thickness of ≧10 μm, preferably of 10 μm to 2 mm, further preferably having a thickness of approximately 50 μm, whereby it is made possible to separate the anode and the cathode of the battery cell only by one or few rigid, tightly compacted and installed diffusion barriers. A use of such a thicker brittle diffusion barrier necessitates thick electrodes, which may not be manufactured using wet-chemical methods, but may be manufactured exclusively by the above-described compression of expanded graphite, the thickness of the electrodes preferably being 50 μm to 2 mm, further preferably ≧150 μm. In this way, a highly porous graphite matrix, into which sulfur may be intercalated, may be used in the lithium-sulfur cell according to the present invention, it being possible for the lithium-sulfur cell having the described composition to be a stacked cell, without encountering the above-described problems.

Cavities may be provided in thicker electrodes to absorb volume changes; electrodes, for example, may also have a layered composition. Due to the volume changes, the electrodes may also be designed with larger cavities, if necessary. These cavities may serve as buffers during volume changes, for example to avoid mechanical stresses and cracks resulting therefrom.

According to one possible refinement of the lithium-sulfur cell according to the present invention, one electrode or each of the electrodes may additionally be provided with at least one separate or additional current collector foil to improve an electron conductivity through the same, in addition to its function as a current collector due to the graphite. Furthermore, one electrode or each of the electrodes of the lithium-sulfur cell according to the present invention may additionally be reinforced with carbon nanotubes (“CNTs”) to increase the conductivity of the electrode even further. In addition to the diffusion barrier, furthermore one or multiple separator foils may be situated between the electrodes in the lithium-sulfur cell according to the present invention, or else alternatively or additionally further functional foils, which increase the safety of the battery cell.

A housing of the lithium-sulfur cell according to the present invention may be a rigid housing. Alternatively, however, it is also possible to use a non-rigid housing, as it is used in so-called pouch cells, for example. The functional principle in the interior of the housing remains the same as already described above. However, the non-rigid housing may be composed of multiple, possibly laminated, aluminum foils, for example, similarly to the manufacture of pouch cells. However, as in the rigid housing, sealing must take place between the diffusion barrier and the pouch cell toward the edge. For example, a seal in the form of an adhesive film may be used in the interior of the pouch film [sic; cell] for this purpose, which bonds with the diffusion barrier in order to completely seal the electrodes from each other. As an alternative, however, it is also conceivable for the pouch cell to have a two-piece composition, each of the two pieces surrounding one electrode and the pieces being connectable to each other at the diffusion barrier. If necessary, preprocessed pouches, for example having provided recesses and/or directly applied seals, may also be used. The pouch foil [sic; cell] is sealingly closed at the still open areas with the aid of welding, a principle known from pouch cell manufacturing.

When only one electrode layer is used in the above-described intercalation method, it may be questionable in some circumstances whether sufficient active material is present in the one electrode layer compared to a known electrode stack or electrode coil. In order to counter this, it is also possible to considerably increase the electrode surface compared to today's cells by the used intercalation method, in addition to the above-described increased electrode layer thicknesses; for example, electrode surfaces of 500 mm×1000 mm at an electrode layer thickness of 500 μm are conceivable. When the lithium-sulfur cell according to the present invention is used in the automotive field, it would be conceivable to integrate the battery plates thereby achievable into the floor plate of a vehicle, for example, in order to utilize the installation space in a meaningful way.

According to one further aspect of the present invention, furthermore a rechargeable lithium-sulfur battery including at least two of the above-described lithium-sulfur battery cells is provided, which are appropriately interconnected with each other.

The electrodes of the lithium-sulfur cell according to the present invention which are composed in the above-described manner may advantageously be manufactured by a kind of dry-coating in which solvents may be dispensed with, i.e., by a solvent-free coating of electrodes. In addition to overcoming the above-described problems of the related art, this solvent-free coating furthermore results in the following technological advantages:
allows high layer thicknesses of the coatings to be manufactured;
allows a high content of highly porous graphite to be used;
allows layer gradients of the coatings to be set;
easier layer thickness control since the same may be measured directly after the foil is manufactured instead of after a drying process, as is the case with the known wet coating;
allows energy expenditures and the hazards to people and the environment to be reduced by avoiding solvents and correspondingly by avoiding the development of solvent emissions; and
makes a smaller overall length of the production line possible.

### BRIEF DESCRIPTION OF THE DRAWING

FIG. 1 shows a schematic sectional view of one specific example embodiment of a lithium-sulfur cell according to the present invention.

### DETAILED DESCRIPTION OF THE INVENTION

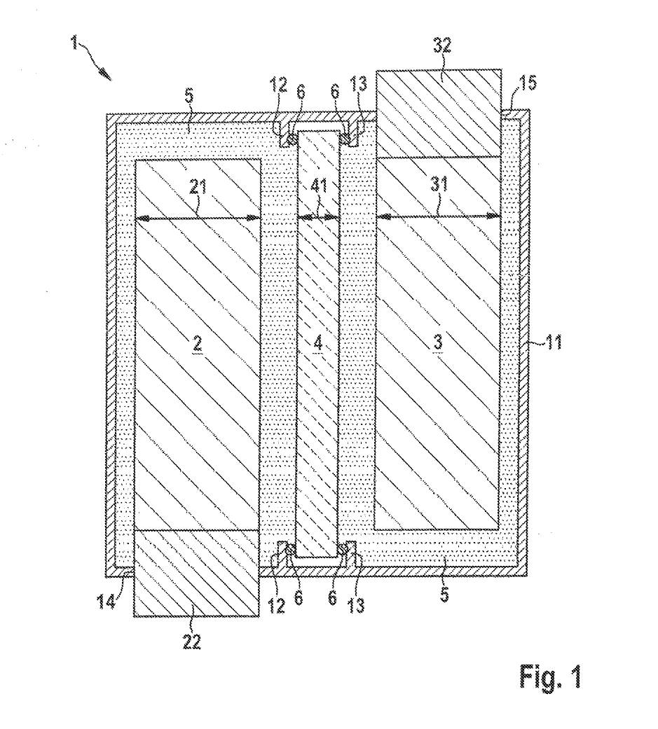

FIG. 1 shows a schematic sectional view, or more precisely a cross-sectional representation of a side view, of one preferred specific embodiment of a lithium-sulfur cell 1 according to the present invention. Lithium-sulfur cell 1 according to the present invention is essentially composed of a housing 11, which may be present in a two-piece structure, for example, such as based on a housing main body and a housing cover, so that it is possible to appropriately compose the interior of cell 1. The interior of cell 1 essentially includes a negative electrode or anode 2, a positive electrode or cathode 3, a diffusion barrier 4 composed of a ceramic plate, and an electrolyte 5. Anode 2 is essentially composed of a porous graphite foil or structure made of compressed expanded graphite, anode 2 in the preferred specific embodiment of lithium-sulfur cell 1 having a thickness 21, i.e., a thickness in a horizontal dimension, of approximately 50 μm to 2 mm. Anode 2 may be designed as metallic lithium, which is coated with protective layers, if necessary. Cathode 3 is situated in housing 11 in parallel to anode 2 and, in the preferred specific embodiment of lithium-sulfur cell 1, is also essentially composed of a porous graphite foil or structure made of compressed expanded graphite, into which sulfur is intercalated, cathode 3 having a thickness 31, i.e., a thickness in a horizontal dimension, of approximately 50 μm to 2 mm. In addition, sulfur is integrated into cathode 3. Both anode 2 and cathode 3 are surrounded by electrolyte 5, which is present in a non-aqueous electrolyte solution here, such as a mixture of different carbonates (ethylene carbonate, diethyl carbonate, dimethyl carbonate) with conducting salts, such as lithium hexafluorophosphate LiPF6, or a mixture of ethylene glycol ethers (dimethoxyethane, tetraethylene glycol dimethyl ether), cyclic ethers (1,3-dioxolane) and conducting salts such as lithium-bis(-trifluoromethyl)-sulfonimide.

Diffusion barrier 4, which separates anode 2 from cathode 3, is situated between anode 2 and cathode 3. In the preferred specific embodiment, diffusion barrier 4 is present in a thickness 41, i.e., a thickness in a horizontal dimension, of approximately 250 μm to 2 mm. Diffusion barrier 4 is situated in housing 11 between protrusions 12, 13 projecting inward on an internal side of housing 11 so that diffusion barrier 4 is essentially situated in parallel to anode 2 and cathode 3. A seal 6 is situated between each protrusion 12 and the held end of diffusion barrier 4 and between each protrusion 13 and the held end of diffusion barrier 4, whereby an area of lithium-sulfur cell 1 in which anode 2 is situated, and an area of lithium sulfur-cell 1 in which cathode 3 is situated, are separated from each other in a fluid-tight manner.

In the preferred specific embodiment, a portion of anode 2 is guided out of housing 11 as a current collector section 22, for example through an opening 14 in housing 11 or the like, current collector section 22 of anode 2 being made of metal to increase a conductivity of anode 2 to the outside and to ensure sealing of electrolyte 5 with respect to the outside. Current collector section 22 of anode 2 guided out of housing 11 thus forms the electrical anode contact of lithium-sulfur cell 1. Similarly, a portion of cathode 3 is guided out of housing 11 as current collector section 32 in the preferred specific embodiment, for example through an opening 15 in housing 11 or the like, current collector section 32 of cathode 3 also being made of metal to increase a conductivity of cathode 3 to the outside and to ensure sealing of electrolyte 5 with respect to the outside. Both anode 2 and cathode 3 of lithium-sulfur cell 1 of the preferred specific embodiment are reinforced with carbon nanotubes, which have been introduced into the particular expanded graphite granules prior to compression, the carbon nanotubes increasing the conductivity of anode 2 and cathode 3.

As a possible refinement of the preferred specific embodiment of lithium-sulfur cell 1 according to the present invention shown in FIG. 1, anode 2 and/or cathode 3 may additionally be provided with at least one additional current collector foil to further increase an electron conductivity. In addition to diffusion barrier 4, furthermore one or multiple separator foils and further functional foils, which increase the safety of the battery cell, may be situated between anode 2 and cathode 3.

What is claimed is:

1. A lithium-sulfur cell, comprising:
a negative electrode;
a positive electrode; and
at least one diffusion barrier situated between the negative electrode and the positive electrode, wherein at least one of the negative and positive electrodes includes a porous graphite foil made of compressed graphite, and wherein the at least one diffusion barrier is made of a brittle material having a thickness of ≧10 μm.

2. The lithium-sulfur cell as recited in claim 1, wherein each of the negative and positive electrodes includes a porous graphite foil made of compressed graphite.

3. The lithium-sulfur cell as recited in claim 2, wherein at least one of the positive and negative electrodes has a multilayer configuration.

4. The lithium-sulfur cell as recited in claim 2, wherein at least one of the positive and negative electrodes is additionally provided with at least one current collector foil.

5. The lithium-sulfur cell as recited in claim 2, wherein at least one of the positive and negative electrodes is additionally reinforced with carbon nanotubes.

6. The lithium-sulfur cell as recited in claim 2, wherein the positive and negative electrodes are formed by compressing expanded graphite.

7. The lithium-sulfur cell as recited in claim 2, wherein at least one separator foil is situated between the positive and negative electrodes.

8. The lithium-sulfur cell as recited in claim 2, wherein the diffusion barrier includes one of a ceramic foil or a ceramic plate.

9. The lithium-sulfur cell as recited in claim 2, wherein at least one of the positive and negative electrodes has a thickness of ≧50 μm.

10. The lithium-sulfur cell as recited in claim 2, wherein:
active material sheathed with binder and conductive carbon black is compressed with the positive electrode, and sulfur is intercalatable into the positive electrode; and
lithium is intercalatable into the negative electrode.

11. A method for manufacturing an electrode for a lithium-sulfur cell including a negative electrode, a positive electrode, and at least one diffusion barrier situated between the negative electrode and the positive electrode, wherein at least one of the negative and positive electrodes includes a porous graphite foil made of compressed graphite, and wherein the at least one diffusion barrier is made of a brittle material having a thickness of ≧10 μm, the method comprising:
manufacturing the porous graphite foil in a calender gap by a compression process in which expanded graphite is compressed, a line load in the calender gap being approximately 6000 N/mm.
